(19) United States
(12) Patent Application Publication
(10) Pub. No.: US 2006/0177372 A1
(43) Pub. Date: Aug. 10, 2006

(54) Method for operating a hydrogen generator

(76) Inventor: Kishore J. Doshi, Fernandina Beach, FL (US)

Correspondence Address: PAULEY PETERSEN & ERICKSON, 2800 W. HIGGINS ROAD, SUITE 365, HOFFMAN ESTATES, IL, 60195, US

(21) Appl. No.: 10/565,306

(22) PCT Filed: Jul. 22, 2004
(86) PCT No.: PCT/US04/23707

§ 371 Date: Jan. 19, 2006

Related U.S. Application Data
(60) Provisional application No. 60/489,300, filed on Jul. 23, 2003.

(51) Int. Cl. C01B 3/26; H01M 8/06

(52) U.S. Cl. 423/652; 429/17

(57) ABSTRACT

Hydrogen generators operating over a range of hydrogen production rates are controlled by alternating production between a net hydrogen make rate and a net hydrogen loss rate. A hydrogen reservoir (150) is provided and the amount of hydrogen in the reservoir is the determinant as to which hydrogen production rate is employed by the hydrogen generator.

### FIELD OF THE INVENTION

This invention relates to methods for controlling a process for generating hydrogen and a combined process for controlling the generation of hydrogen and for generating electrical power, especially for a combined process that also provides purified hydrogen for other uses.

### BACKGROUND OF THE INVENTION

Hydrogen has been often proposed as an alternative fuel especially for use in fuel cells in stationary and mobile facilities and is used as a feedstock for many chemical processes. Steam reforming of hydrocarbon-containing feedstock is a conventional source of hydrogen. Steam reforming of hydrocarbons is practiced in large-scale processes, often integrated with refinery or chemical operations. Thus, due to their large scale and available skilled labor force, these practitioners of steam reforming can rely upon sophisticated unit operations to economically produce hydrogen.

For hydrogen to be accepted as an alternative fuel, and for small-scale chemical processes, hydrogen must be readily available. Hydrogen is difficult to store and distribute and has a low volumetric energy density compared to fuels such as gasoline. Thus, it is desirable to be able to generate hydrogen for use or distribution at a point proximate to the consumer such that a hydrocarbon-containing feedstock to the hydrogen generator is the material shipped and stored. For example, a hydrocarbon-containing fuel may be provided to a residence or a fueling station and converted at that location to hydrogen for use in a fuel cell or vehicle. However, the demand for hydrogen at such use or distribution points may be relatively small. A home may need less than 40 kilograms of hydrogen per week to meet all electrical power needs. Similarly, an automobile powered by hydrogen may travel 1000 kilometers or more on 25 kilograms of hydrogen.

Much greater challenges exist in producing hydrogen in smaller scale units than for the large industrial-scale hydrogen generators. The severity of this challenge is increased where the fuel cell is for residential or small business use. Not only will the hydrogen generator need to operate without sophisticated technical expertise provided by plant operators, but the generator and its operation must be sufficiently economical to be competitive, be compact and require minimal maintenance. Moreover, the demand for hydrogen will likely not be constant in a small business or residential environment. For instance, in residential applications, the power requirements fluctuate from time to time within a day and from day to day. Similarly, a hydrogen distributor for mobile users may experience swings in demand such as are currently experienced by gasoline distributors.

Considerable effort has been devoted to developing small-scale hydrogen generators, especially hydrogen generators that are compact and accommodate changes in demand. However, many of the proposed hydrogen generators require complex control systems dependent upon the measurement of many operating variables with in the hydrogen generator. Moreover, with time, the performance of the hydrogen generator may change. For example, if natural gas is used as the feedstock, changes in composition may occur and more or less hydrocarbon may be contained per unit volume. Also, catalysts used in the hydrogen generator may deteriorate, heat exchanges may foul and mechanical equipment may suffer in performance. These performance changes can also add to the complexity of a control system.

A need exists for hydrogen generators that do not require complex control systems and have high reliability, especially hydrogen generators that can meet peak hydrogen demands without requiring exceptionally large hydrogen generation capacities to meet short term needs. Further, hydrogen generators are sought that can readily be operated at remote locations. Additionally, hydrogen generators are sought that can serve multiple needs for hydrogen.

U.S. Pat. No. 6,617,066 (prior publication US 2001/0031386, Oct. 18, 2001) discloses the use of a hydrogen reservoir in a fuel cell power generation system comprising a reformer and a fuel cell. A distributing valve is used to direct to the fuel cell sufficient hydrogen and the remaining hydrogen is supplied to the hydrogen reservoir. The hydrogen in the reservoir can be drawn upon during periods of shortfall in hydrogen production by the reformer, e.g., during a sudden acceleration. The primary control over the hydrogen production rate is based upon the hydrogen demand rate for the fuel cell.

Similarly U.S. Patent Application Publication No. 2004/0058209, Mar. 25, 2004, discloses a fuel processor and fuel cell system with a hydrogen storage vessel to receive purified hydrogen from a slip stream. During operation, hydrogen from the reformer that is not needed for the fuel cell is directed to a hydrogen separator such as an electrochemical separator to provide a purified hydrogen stream that is fed to the hydrogen storage vessel. The hydrogen separator may be operated at steady state conditions and turned off when hydrogen is no longer needed, or it may be operated in a variable output mode dependent upon the hydrogen demands of the fuel cell. See, for instance, paragraph 53 on page 5 of the publication. The publication indicates that hydrogen in the hydrogen storage vessel can be used to meet peak demands of the fuel cell.

These documents, while disclosing the use of hydrogen storage vessels, provide no disclosure or suggestion that the hydrogen storage vessel can be used as the primary variable for controlling the reformer, let alone how that control is to be effected.

### SUMMARY OF THE INVENTION

The methods of this invention provide for a simple, yet effective, control for the operation of a hydrogen generator and of a combined hydrogen generator and fuel cell apparatus. The methods also enable the supply of purified hydrogen for uses other than the generation of electricity. For example, the methods are suitable for residential uses including for electricity generation and vehicle refueling, small-scale hydrogen distributors or for small chemical processes.

In the control methods of this invention, the rate of hydrogen generation is not directly related to demand for hydrogen. Hence, peak hydrogen demands may be satisfied without requiring large hydrogen generator capacities. And, the sophistication of control for chemical reaction unit operations that must be performed by the hydrogen generator can be minimized without undue sacrifice in economy of operation or hydrogen product quality.

By the control methods of this invention, a hydrogen stream produced by reforming a hydrogen and carbon-containing fuel is accumulated in a reservoir, and the rate of production of hydrogen by reforming is within a first rate range sufficient to accumulate hydrogen in the reservoir and once a predetermined amount of hydrogen is accumulated, changing the production of hydrogen to a rate within a second rate range which is insufficient to maintain the first amount of hydrogen in the reservoir, and upon a predetermined second amount of hydrogen being in the reservoir, said second amount being less than the first amount, changing the hydrogen production rate to a rate within said first rate range. Thus, for example, the reservoir may contain sufficient hydrogen for use on an episodic basis such as for refueling quickly an automobile, and the used hydrogen can be replaced over time by the operation of the hydrogen generator once the reserve of hydrogen falls below a predetermined amount. In another aspect of the invention, the capacity of the reservoir may be relatively small and sized only to accommodate the time for the transition between the rate within the second (net production loss) rate range and the rate within the first (net hydrogen make) rate range. Thus, the amount of hydrogen storage can be nominal and lags in turn-up response by the hydrogen generator can be tolerated while still fully supplying hydrogen demand.

The advantages of the control methods are readily apparent in that the hydrogen generator need only be operated within rate ranges. The methods of the invention are relatively insensitive to the conditions of the raw materials and the hydrogen generator. There is no need for the hydrogen generator to precisely and reproducibly meet a hydrogen production rate specification. Indeed, so long as the first rate is a net hydrogen make rate and the second rate is a net production loss rate, subject to maintaining product quality, the absolute production rate within each range is relatively immaterial. The second rate may be no production of hydrogen, i.e., the hydrogen generator may be shut down. Alternatively, the second rate may be sufficient to partially offset the use of hydrogen, say, from internal consumption of electricity from the fuel cell to maintain operation of the hydrogen generator in a reduced production or stand-by mode, or from continuing external use, e.g., if the fuel cell is used to provide electricity externally. In accordance with the invention, it is contemplated that there may be two or more rate ranges to accommodate the need for hydrogen at a given time. Thus, say, if hydrogen were used in a residential environment both for the production of power and an episodic purpose such as the supply of hydrogen to a vehicle, there may be a first and second rate range established for a high usage situation when the home is actively occupied and frequent refuelings occur, and another first and second rate range when the home is idle and no recent refueling has occurred.

In the preferred aspects of the invention, a pressure swing adsorber is used to purify the hydrogen, thus operations such as a low temperature water gas shift or selective oxidation to reduce carbon monoxide, need not be used. Typically these unit operations are relatively sensitive to operating conditions such as temperature. Hence, not only is the number of unit operations to be controlled, but also the complexity of the control system is materially reduced.

Carbon monoxide must be at very low concentrations in the hydrogen product as it is a poison to PEM-type fuel cells. The performance of carbon monoxide reducing unit operations such as water gas shift and selective oxidation are sensitive to process conditions. For instance, an increase in shift reactor temperature can result in more carbon monoxide being present in its effluent. In the aspects of the invention using pressure swing adsorption, especially where the reforming is a partial oxidation reforming using a nitrogen and oxygen-containing gas, adequately pure hydrogen can readily be provided while maintaining very low carbon monoxide concentrations even though the concentration of carbon monoxide in the reformate or from any carbon monoxide reducing unit operation may vary. As the adsorption system assures the absence of carbon monoxide in the purified hydrogen product, it is not as critical that the control system for the reformer and any carbon monoxide reducing unit operations carefully manage carbon monoxide concentrations. If desired, the cycle time for the pressure swing adsorption may be decreased where higher carbon monoxide breakthrough occurs from any carbon monoxide reducing unit operation such as a water gas shift.

Advantageously, the control for the fuel cell can be independent of the control for the hydrogen generator thereby reducing complexity.

In a broad aspect of the invention, a method for controlling a process for generating hydrogen by reforming a hydrocarbon-containing feed at elevated temperature in the presence of water to produce a reformate containing at least about 3 volume percent carbon monoxide (dry basis), reducing the carbon monoxide content of the reformate to less than about 100, preferably less than 20, and most preferably less than about 10, parts per million by volume of carbon monoxide (dry basis), maintaining a reservoir of hydrogen generated by reforming, preferably the purified hydrogen product stream, and withdrawing hydrogen from the reservoir comprises:
a) generating hydrogen at a first rate within a first rate range sufficient to accumulate hydrogen in the reservoir,
b) upon a predetermined first amount of hydrogen being accumulated in the reservoir, changing the rate of hydrogen generation to a second rate within a second rate range insufficient to maintain the first amount of hydrogen in the reservoir, and
c) upon a predetermined second amount of hydrogen being in the reservoir, said second amount being less than the first amount, changing the rate of hydrogen generation to a rate within said first rate range.

The more preferred methods of the invention involve controlling a combined process for generating hydrogen and using hydrogen for generating electrical power. The hydrogen generation is by reforming a hydrocarbon-containing feed at elevated temperature in the presence of water to produce a reformate containing at least about 3 volume percent carbon monoxide (dry basis), subjecting the reformate to water gas shift conditions including the presence of a water gas shift catalyst and the presence of water to react carbon monoxide with water to produce a shift effluent containing at least about 0.1 volume percent carbon monoxide (dry basis), cooling the shift effluent to a temperature below about 100° C. and removing condensed water, providing the shift effluent at least a pressure suitable for pressure swing adsorption to obtain a purified hydrogen stream, and recovering hydrogen from the reformate by pressure swing adsorption to provide a purified hydrogen product stream containing at least 98 volume percent hydrogen (dry basis) and less than about 100, preferably less than 20, and most preferably less than about 10, parts per million by volume of carbon monoxide (dry basis) and provide a purge stream containing hydrogen and carbon monoxide at least a portion of which purge stream is combusted to provide heat for the reforming. Hydrogen is accumulated in a reservoir and withdrawn as needed. The accumulation may occur either before or after purification. At least a portion of the purified hydrogen is reacted with oxygen-containing gas in a fuel cell to provide electricity. In the control method:
a) hydrogen is generated at a first rate within a first rate range sufficient to accumulate hydrogen in the reservoir,
b) upon a predetermined first amount of hydrogen being accumulated in the reservoir, the rate of hydrogen generation is changed to a second rate within a second rate range insufficient to maintain the first amount of hydrogen in the reservoir, and
c) upon a predetermined second amount of hydrogen being in the reservoir, said second amount being less than the first amount, the rate of hydrogen generation is changed to a rate within said first rate range.

In one preferred embodiment, the reforming comprises a partial oxidation of hydrocarbon-containing feed fed to the reforming and nitrogen and oxygen-containing gas is also fed to the reforming, and the rate of hydrocarbon-containing feed to the reforming is the primary variable changed when changing the rate of hydrogen generation, and the rate of nitrogen and oxygen-containing gas is adjusted to maintain the reformer within the predetermined temperature range. The rate of production of hydrogen is whatever rate is actually produced at the given hydrocarbon-containing feed rate, hydrogen generator process conditions and catalyst and equipment conditions.

In an alternative preferred embodiment, the reforming is steam reforming and the combustion comprises the combustion of the purge stream and combustion of hydrocarbon-containing feed to provide heat through indirect heat exchange, and the rate of hydrocarbon-containing feed to the reforming is the primary variable changed when changing the rate of hydrogen generation and the rate of hydrocarbon-containing fuel for the combustion is adjusted to maintain the reformer within the predetermined temperature range. The rate of production of hydrogen is whatever rate is actually produced at the given hydrocarbon-containing feed rate, hydrogen generator process conditions and catalyst and equipment conditions.

In an other broad aspect of the invention, methods are provided for the control of a process for generating hydrogen by reforming a hydrocarbon-containing feed at elevated temperature in the presence of water and nitrogen and oxygen-containing gas whereby a portion of the feed is partially combusted to provide heat for reforming to produce a reformate containing water, hydrogen, nitrogen, carbon dioxide and at least about 3 volume percent carbon monoxide (dry basis), optionally subjecting the reformate to water gas shift conditions including the presence of a water gas shift catalyst and the presence of water to react carbon monoxide with water to produce a shift effluent containing at least about 0.1 volume percent carbon monoxide (dry basis), cooling the shift effluent to a temperature below about 100° C. and removing condensed water, providing the shift effluent at least a pressure suitable for pressure swing adsorption to obtain a purified hydrogen stream, and recovering from the reformate during an adsorption cycle of a pressure swing adsorber hydrogen a purified hydrogen product stream containing at least 98 volume percent hydrogen and less than about 100, preferably less than 20, most preferably less than 10, parts per million by volume of carbon monoxide (dry basis) and provide during a purge cycle a purge stream containing nitrogen, carbon dioxide, hydrogen and carbon monoxide at least a portion of which purge stream is combusted to provide heat for the reforming, and optionally accumulating in a reservoir purified hydrogen product stream from the adsorption cycle, comprising:
a) generating hydrogen at a first rate within a first rate range,
b) changing the rate of hydrogen generation to a second rate within a second rate range,
c) changing the rate of hydrogen generation to a rate within said first rate range, and
d) maintaining a substantially constant pressure swing cycle time for the adsorption and purge at both the first rate and second rate of hydrogen generation and allowing the purity of the purified hydrogen stream to vary.

### BRIEF DESCRIPTION OF THE DRAWINGS

FIG. 1 is a schematic diagram of an apparatus for generating hydrogen and electricity that is adapted for use with the control method of this invention.

FIG. 2 is a schematic representation of a control system associated with the apparatus of FIG. 1.

FIG. 3 is an illustrative graphic representation of the adsorbed components over the length of an adsorber bed at the end of an adsorption cycle.

FIG. 4 is a schematic representation of a four bed pressure swing adsorber useful in this invention.

FIG. 5 is a graphic illustration of the operation of the control methods of this invention.

### DETAILED DESCRIPTION OF THE INVENTION

The hydrocarbon-containing feeds used in accordance with the invention are typically gaseous under the conditions of reforming. Lower hydrocarbon gases such as methane, ethane, propane, butane and the like may be used. Because of availability, natural gas and liquid petroleum gas (LPG) are most often used as feeds. Oxygenated hydrocarbon-containing feeds such as methanol and ethanol are included as hydrocarbon-containing feeds for all purposes herein.

Natural gas and liquid petroleum gas typically contain odorants such that leaks can be detected. Odorants conventionally used are one or more organosulfur compounds such as organosulfides, e.g., dimethyl sulfide, diethyl sulfide, and methyl ethyl sulfide; mercaptans, e.g., methyl mercaptan, ethyl mercaptan, and t-butyl mercaptan; thiophenes of which tetrahydrothiophene is the most common; and the like. The amount used can vary widely. For natural gas, the organosulfur component is often in the range of about 1 to 20 parts per million by volume (ppmv); and for LPG a greater amount of sulfur compounds are typically used, e.g., from about 10 to 200 ppmv. It is not unusual for commercially obtained hydrocarbon feeds to also contain other sulfur compounds which may be natural impurities such as hydrogen sulfide and carbonyl sulfide. Carbonyl sulfide concentrations in natural gas and LPG of 0.1 to 5 ppmv are not unusual.

Regardless of the form, sulfur compounds are generally undesirable in the product hydrogen and can be deleterious to catalysts used in hydrogen generators such as water gas shift catalysts. The processes of this invention provide flexibility in where sulfur is removed. If desired, the hydrocarbon-containing feed can be desulfurized. Any convenient desulfurization technique may be used including sorption and hydrodesulfurization. In an aspect of this invention, the desulfurization occurs subsequent to reforming. In the reforming process, substantially all the sulfur components are converted to hydrogen sulfide. Hydrogen sulfide can then be removed from the reformate by sorption. If desired a guard bed can be used upstream of the reformer containing transition metal exchanged molecular sieve such as zinc or copper exchanged zeolite X or zeolite Y to assist in the removal of sulfur compounds, especially thiophenes such as tetrahydrothiophene.

The feeds can contain other impurities such as carbon dioxide, nitrogen and water. In the processes of this invention, it is preferred that the concentration of carbon dioxide be less than about 5, preferably less than about 2, volume percent.

Water in addition to that contained in the other feed components to the process may be required. This additional water preferably is deionized. The source of the oxygen-containing raw material may be pure oxygen, oxygen-enriched air, or most conveniently, air. When enriched, the air frequently contains at least about 25, often at least about 30, volume percent oxygen. The nitrogen and oxygen-containing gas useful in this invention preferably contains at least about 20 volume percent nitrogen and is frequently air or oxygen-enriched air.

Hydrogen generating processes are known and may use a variety of unit operations and types of unit operations. For instance, the feed components to the reformer are typically admixed prior to being passed to the reformer. The feed, or components of the feed, can be heated prior to entry into the hydrogen generator or within the hydrogen generator. In some instances it may be desired to heat the fuel prior to admixing with steam and, in the case of partial oxidation reforming, oxygen, especially if the fuel is a liquid under normal conditions to vaporize it.

The reforming may be via steam reforming alone or may be effected by a combination of partial oxidation of the fuel being passed to the reformer and steam reforming. Steam reforming is a catalytic reaction producing hydrogen and carbon oxides (carbon dioxide and carbon monoxide) conducted under steam reforming conditions. Steam reforming conditions usually comprise temperatures in excess of 600° C., e.g., 600° C. to 1000° C., and pressures of from about 1 to 25 bar absolute.

Partial oxidation reforming conditions typically comprise a temperature of from about 600° C. to about 1000° C., preferably about 600° C. to 800° C. and a pressure of from about 1 to about 25 bar absolute. The partial oxidation reforming is catalytic. The overall partial oxidation and steam reforming reactions for methane are expressed by the formulae:
CH₄+0.5 O₂→CO+2H₂
CH₄+H₂O [symbol] CO+3H₂

The reformer may comprise two discrete sections, e.g., a first contact layer of oxidation catalyst followed by a second layer of steam reforming catalyst, or may be bifunctional, i.e., oxidation catalyst and steam reforming catalyst are intermixed in a single catalyst bed or are placed on a common support. The partial oxidation reformate comprises hydrogen, nitrogen (if air is used as the source of oxygen), carbon oxides (carbon monoxide and carbon dioxide), steam and some unconverted hydrocarbons.

The reformate, reforming effluent, is a gas and is preferably subjected to one or more carbon monoxide reducing unit operations. A water gas shift is most typically used. Generally, the shift reactor contains at least one water gas shift reaction zone. The reformate is typically at temperatures in excess of about 600° C. as it exits the reformer. The reformate contains hydrogen, carbon dioxide and carbon monoxide as well as water. On a dry basis, the components of the effluent from the reformer fall within the ranges set forth below:

REFORMER EFFLUENT COMPONENTS,
MOLE PERCENT DRY BASIS

| Component | Steam Reforming | Autothermal Reforming |
|---|---|---|
| Hydrogen | 50 to 80, | 35 to 60, frequently 40 to 45 |
| | frequently 70 to 75 | |
| Nitrogen | 0 to 3, | 10 to 40, frequently 20 to 35. |
| | frequently 0 to 1 | and for air, frequently 30 to 35 |
| Carbon monoxide | 3 to 15, | 3 to 15, frequently 3 to 10, |
| | frequently 5 to 10 | and for air, frequently 3 to 6 |
| Carbon dioxide | 10 to 25, | 10 to 25, frequently 12 to 20, |
| | frequently 15 to 20 | and for air, 12 to 15 |

The reformate is cooled prior to being passed to the shift reactor to water gas shift conditions. In the shift reactor carbon monoxide is exothermically reacted in the presence of a shift catalyst and in the presence of an excess amount of water to produce additional amounts of carbon dioxide and hydrogen. The shift reaction is an equilibrium reaction. The reformate thus has a reduced carbon monoxide content.

Although any number of water gas shift reaction zones may be employed to reduce the carbon monoxide level in the hydrogen product, the preferred processes of this invention using pressure swing adsorption for hydrogen purification use only a high temperature shift at high temperature shift conditions comprising temperatures between about 320° C. and about 450° C. As the hydrogen-containing stream is purified by pressure swing adsorption, the use of more stages of water gas shift or selective oxidation to further reduce the amount of carbon monoxide unduly increases the expense and complexity of the hydrogen generator.

In the broader aspects of the invention, other carbon monoxide reducing unit operations may be used such as, selective permeation through membranes and low temperature shift followed by selective oxidation to preferentially oxidize carbon monoxide to carbon dioxide without undue combustion of hydrogen. These unit operations can reduce carbon monoxide content to less than 100 parts per million by volume without the need for pressure swing adsorption. However, in the latter unit operation, achieving high purity hydrogen will necessitate removal of inerts such as carbon dioxide and, in the case of partial oxidation reforming, nitrogen. This removal can be done by any suitable means such as membrane separation and selective adsorption.

In preferred embodiments of the invention using a pressure swing adsorber, the water gas shift effluent stream typically comprises at least about 1, often greater than about 2, say, 2 to 5, volume percent carbon monoxide (on a dry basis). The effluent will also contain water and will typically be at a temperature higher than that most advantageous for pressure swing adsorption. Accordingly, the stream is cooled to a temperature below about 100° C., preferably to a temperature in the range of about 30° to 80° C., and most preferably to about 350 to 65° C. Under these conditions, water will be condensed and can be removed from the stream.

It is usually necessary to provide the shift stream at an elevated pressure for advantageous pressure swing adsorption operation. Usually pressures in the range of about 5 to 15 bar absolute (500 to 1500 kPa), preferably about 5 to 10 bar absolute (500 to 1000 kPa), are desired. The compression may occur at any point prior to the pressure swing adsorption. The feed to the reformer, e.g., hydrocarbon-containing gas and oxygen, in the case of a partial oxidation reforming, may be compressed and thus the stream to the adsorber will be at a suitable pressure. Alternatively, the hydrogen-containing stream may be compressed immediately before the pressure swing adsorption. The compressor may be water cooled with the heated water being used for heat recovery or as a hot water supply external to the apparatus.

Pressure swing adsorption is preferably used to purify the reformate. Desirably the pressure swing adsorption provides a hydrogen product stream of at least about 98, preferably at least 99, volume percent and contains less than about 100, preferably less than about 10, ppmv of carbon monoxide (dry basis). Usually the pressure swing adsorption recovers at least about 65, preferably at least about 80, percent of the hydrogen contained in the stream fed to the pressure swing adsorption.

Any suitable adsorbent or combination of adsorbents may be used for the pressure swing adsorption. The particular adsorbents and combinations of adsorbents used will, in part, depend upon the components of the feed to the pressure swing adsorber, the sought compositions in the purified hydrogen product and the geometry and type of pressure swing adsorber used. Adsorbents include molecular sieves including zeolites, metal oxide or metal salt, and activated carbon. Particularly advantageous sorbents include a combination of sorbents with the first portion of the bed being composed of activated carbon which is particularly effective for water and carbon dioxide removal followed by one or more molecular sieves such as NaY, 5A, lithium or barium exchanged X, silicalite and ZSM-5. The sorbents may be of any suitable particle size given the constraints of pressure drop and bed lifting for an up-flow fixed bed.

The pressure swing adsorber may be of any suitable design including rotary and multiple bed. The purging of the bed may be by vacuum, but most conveniently for simplicity, the purge is above ambient atmospheric pressure. A preferred pressure swing adsorption system for low maintenance operation uses at least four fixed beds. By sequencing the beds through adsorption and regeneration steps, a continuous flow of purified hydrogen stream can be achieved without undue loss of hydrogen. With at least four beds, one bed at a given time will be adsorbing, another will be providing purge, another will be undergoing purging and another will be undergoing repressurization. Preferably, at least one, and more preferably two or three, pressure equalization steps are used to increase hydrogen recovery.

The operation of the pressure swing adsorber will also be influenced by the cycle time and the ratio of the pressures for the swing. As stated above, the sorption may be at 500 to 1500 KPa, the purge usually occurs within about 100, preferably within about 50, say, 10 to 50, KPa above ambient atmospheric pressure. The cycle times are selected to provide the hydrogen product of a desired purity. For a given pressure swing adsorber system, as the cycle times become shorter, the purity achievable increases, but also, less hydrogen is recovered. Thus, the cycle times and adsorber sizing can be selected for a given unit based upon the hydrogen specification and sought recovery.

In one mode of operation, the cycle times may change when the hydrogen rate changes. Thus, when an increase in hydrogen production occurs, the cycle times may shorten, for instance, to maintain substantially constant hydrogen product purity. In another mode, the cycle times may remain substantially constant over a range of hydrogen production rates. Hence, the cycle times may vary in a step manner with constant cycle times over ranges of hydrogen production rates, or may be constant over the entire range of hydrogen production rates. In this mode of operation of the pressure swing adsorber where the cycle times are maintained constant at least over a range of hydrogen production rates, the cycle time is preferably set to provide acceptable hydrogen purity at the highest expected feed rate to the adsorber and the highest expected carbon monoxide concentrations at steady state operation (excluding momentary peaks of carbon monoxide content due to instability in the operation of the hydrogen generator). The cycle time would remain the same even at operations within lower production rate ranges. Although some efficiency loss will occur, complexities and costs in the control of the pressure swing adsorber can be avoided.

A particularly attractive aspect of this invention involves processes in which the reforming involves a partial oxidation and the oxidizing gas is a nitrogen and oxygen-containing gas. Although nitrogen may need to be removed to meet product quality specifications, many adsorbents are more selective for the sorption of carbon monoxide than nitrogen. Hence, significant nitrogen breakthrough from the adsorption bed will occur prior to any significant carbon monoxide breakthrough. Moreover, the presence of nitrogen will further reduce the partial pressure of carbon monoxide during desorption and thus enhance carbon monoxide removal efficiency. One useful bed configuration comprises activated carbon as the leading portion. In that section of the bed, water, carbon dioxide and hydrocarbon are selectively adsorbed. The remaining portion of the bed comprises lithium X molecular sieve.

The control methods of this aspect of the invention can take advantage of these features by setting a fixed cycle time for the system based on the permitted nitrogen concentration in the purified hydrogen product for the highest throughput rate. At lesser throughput rates, the amount of nitrogen breakthrough will decrease. For hydrogen uses such as fuel cells, the purified hydrogen product will have very low concentrations of carbon monoxide, even below about 5 ppmv, and the variation in nitrogen content over the range of production rates, can readily be tolerated by, say, a fuel cell system. For some uses of hydrogen such as annealing, the presence of nitrogen may be beneficial.

An additional advantage is that the purge from the pressure swing adsorber will contain hydrogen and carbon monoxide which can be combusted to provide heat for the reforming. Thus the purge does not represent an undue efficiency loss from the overall hydrogen generator as it offsets the use of fuel that would have to be combusted to provide the heat. The heat from the combustion of the purge can be used to heat streams that are ultimately fed to the reformer or can be used to supply heat via indirect heat exchange with the reformer. One preferred embodiment is to use the purge to heat the nitrogen and oxygen-containing gas to a partial oxidation reformer. In some instances, the combustion heat from the purge will be sufficient as the sole source of fuel for heating the nitrogen and oxygen-containing gas.

In accordance with the control methods of this invention, hydrogen from the reforming is accumulated in a reservoir. The reservoir may be a pressure vessel, including a vessel used for pressure swing adsorption for purification of hydrogen, or metal hydride sorption medium or any other convenient means for hydrogen storage. The pressure vessel for storage of hydrogen may operate at essentially the pressure at which the hydrogen is supplied, or additional compression may be employed. For instance, it may be desirable to store hydrogen at a pressure of at least 1000 kPa above atmospheric. The higher pressure reduces the size of the reservoir for a given molar capacity of hydrogen and may also be desirable from the standpoint of being at a pressure desirable for supplying hydrogen, e.g., to refuel hydrogen tanks for vehicles.

Usually for metal hydride storage media, hydrogen is sorbed at low temperatures, e.g., temperatures less than about 35° C., and then released by heating the media, e.g., at temperatures in excess of 50° C. If desired, heat from the hydrogen generator such as to cool water gas shift effluent can be used as at least a portion of the heat source to effect hydrogen release.

The hydrogen stored may be hydrogen still requiring removal of one or more components prior to use or may be a purified hydrogen stream. In the preferred aspects of the invention, the reservoir for storage of the hydrogen is subsequent to the purification.

If desired, the hydrogen product stream may be additionally compressed. If so, all or part of the hydrogen product for use in the fuel cell may be withdrawn prior to such additional compression and a separate reservoir for hydrogen product for use in the fuel cell may be employed.

The fuel cells used in accordance with the invention are those in which oxygen and hydrogen are reacted. In the hydrogen/oxygen fuel cell, the processes at the anode and cathode, respectively, are:
H₂=2H⁺+2e (anode process); (1)
and,
O₂+4e+4H⁺=2H₂O (cathode process) (2).

The oxygen is often provided as air or enriched air. A cathode waste gas will be generated to remove nitrogen and other non-reactive components contained in the air or enriched air stream. This stream may be discharged or used as a source of reduced oxygen for combustion.

The preferred fuel cells are known as PEM (proton exchange membrane) fuel cells. PEM fuel cells comprise layers of catalyst comprising platinum and platinum alloys on the anode and cathode sides. These catalyst layers consist of fine, noble metal particles which are deposited onto a conductive support material (generally carbon black or graphite). The concentration of noble metal is between 10 and 40 wt-% and the proportion of conductive support material is thus between 60 and 90 wt-%. The crystallite size of the particles, determined by X-ray diffraction (XRD), is 2 to 10 nm. Traditional platinum catalysts are very sensitive to poisoning by carbon monoxide; therefore the carbon monoxide content of the fuel gas is preferably less than 100 parts per million by volume (ppmv) in order to prevent unduly fast power loss in the fuel cells. Since the PEM fuel cell operates at a relatively low operating temperature of between 70° and 100° C., the catalyst is especially sensitive to carbon monoxide poisoning.

The hydrogen product can be used for generation of electrical power, for a supply of hydrogen for chemical processes or for supply to vehicles using hydrogen as a fuel. In accordance with the invention, a fuel cell is used at least to provide internal electrical power for the apparatus, e.g., to operate compressors and provide power for control systems. Most advantageously, the apparatus is used to provide electrical power external to the apparatus. For instance, the apparatus may be scaled for use in a residential environment to provide electrical power needs and provide a supply of hydrogen as fuel for vehicles. Similarly, small scale distributors of hydrogen, e.g., local fueling service stations, may use the apparatus not only to generate hydrogen for refueling and electricity for use at the service station but also the size may make feasible to provide excess electrical power into a power grid.

The reservoir may comprise a single vessel or type of storage mechanism or a plurality of vessels or different storage mechanisms. By way of example, a two tiered storage mechanism may be used with a lower pressure storage which supplies the fuel cell and a second tier storage, which may be a high pressure storage or a metal hydride storage, that is suitable for the supply of hydrogen for, e.g., refueling or chemical process operations. The second tier storage may be comprised of cartridges which can, for instance, be removed and placed in a vehicle and replaced for recharging upon depletion of the hydrogen. Another alternative for the reservoir for the purified hydrogen product is parallel storage with one storage reservoir being for the fuel cell and another being for other supply which may be at the same or different conditions and may be the same or different type of storage mechanism.

In accordance with the control methods of this invention, the hydrogen production rate is within a first rate range until the amount of hydrogen in the reservoir reaches a predetermined amount (full amount). This rate is in essence a net hydrogen make rate, that is, under the operation of the apparatus, operation at the net hydrogen make will replenish hydrogen withdrawn for the fuel cell and for other uses. If, say, the withdrawal of hydrogen from the apparatus involves periodic significant withdrawals such as would be the case for refueling, it is anticipated that although the hydrogen production rate is at a net make rate, the actual amount of hydrogen in the reservoir may decrease from time to time due to these periodic significant withdrawals. The net hydrogen make rate is thus determined over a period of time reflecting the periodic significant withdrawals. For instance, if the hydrogen generator is to supply hydrogen for electric power and for periodic refueling of a vehicle, the minimum net hydrogen make rate will be that sufficient to just exceed demand between the periodic withdrawals for refueling. Say, if 50 kilograms of hydrogen are needed for internal use and 25 kilograms of hydrogen are needed for refueling every seven days, the minimum net hydrogen make rate would be just in excess of 75 kilograms of purified hydrogen product production per week.

How frequently the amount of hydrogen in the reservoir reaches the predetermined amount will depend upon the rate of use of the hydrogen product and the capacity of the reservoir. Hence, the duration the net hydrogen make phase may vary widely, for instance, from minutes to weeks. Moreover, in applications where the demand for hydrogen may fluctuate widely such as a residential use, the duration of a hydrogen make phase would also fluctuate widely.

In general, the capacity of the reservoir should be sufficient to meet peak hydrogen demands. The capacity is thus determinable by one skilled in art given the expected rate of use of hydrogen and the net hydrogen make rate. Preferably, the amount of hydrogen remaining in the reservoir at the predetermined second capacity is such that any significant, rapid demand for hydrogen can be met. Thus, in a home refueling station, the amount remaining in the reservoir prior to changing to a net hydrogen make mode will be sufficient to enable a refueling to occur and still provide ample hydrogen to the fuel cell to meet the electrical demand for the residence as the supply of hydrogen at the net make rate replenishes the reservoir.

Contemplated within the broad aspects of this invention is the use of a reservoir even where the demand for hydrogen is substantially constant. Thus, the control method need not precisely match the demand for hydrogen. The size of the reservoir may be relatively small; however, more frequent changes in production rates between the first rate range and the second rate range may be necessitated.

In this aspect of the invention, a pressure swing adsorber may serve as the reservoir. In a pressure swing adsorber, some of the purified hydrogen product is used to repressurize a purged bed. The valve controlling the split of the flow of hydrogen to the external demand, such as a fuel cell, and the repressurizing bed is set to meet the external demand. The rate of hydrogen flow to the repressurizing bed is determined. If it exceeds a predetermined rate, the rate of hydrogen generation is changed from a net hydrogen make rate to a net hydrogen loss rate. If it falls below a predetermined rate, the rate of hydrogen generation is changed from a net hydrogen loss rate to a net hydrogen make rate. The predetermined values are sufficiently separated and the changes in rates are delayed such that rapid cycling of hydrogen generation rate does not occur. During a period where excess purified hydrogen product is supplied to the bed during repressurization, some of the hydrogen can be bled off with the purge. Where insufficient hydrogen is provided to repressurize fully the bed, the remaining repressurization will occur upon introduction of the feed to the bed.

The amount of hydrogen in the reservoir is the triggering value to switch from the first hydrogen production rate to the second hydrogen production rate (net hydrogen depletion rate). The detection of the amount of hydrogen in the reservoir may be by any suitable means including direct measurements or indirect measurements as discussed above. Where more than one vessel is used, the vessel or vessels that this measurement occurs may vary. For instance, if sequential vessels are used, either the initial vessel which feeds the subsequent vessels may be used as the vessel that is monitored. Alternatively the last vessel may be the vessel monitored.

The net hydrogen depletion rate is selected such that exceeding the capacity of the reservoir does not occur. This rate will be determined from the expected minimum demand for hydrogen. At one extreme, the second rate may be a shut down of the apparatus. Or the net depletion rate may be selected to be slightly below that required for internal electric power consumption (e.g., standby mode). If the apparatus is providing a predictable, constant external supply of hydrogen, the net depletion rate may be slightly below the rate required to meet that supply demand.

It should be understood that within the scope of this invention is contemplated the use of more than one net hydrogen make rate and more than one net hydrogen depletion rate. Usually, the most attractive operation of the hydrogen generator is at substantially the maximum design rate, and approximately that rate is used for a net hydrogen make rate. However, other factors such as limited fuel supply may necessitate or make advantageous the use of a lower net hydrogen make rate. Similarly, the net hydrogen depletion rate may be selected from a shut down, a standby or a minimum external supply rate (determined by a continuous demand for hydrogen for the fuel cell or external distribution). For instance, upon reaching fall capacity in the reservoir, the control system may first go to a minimum external supply rate, and if the operation is still in a net hydrogen make mode, then go to a standby mode. If the apparatus remains in a standby mode for a predetermined given duration, then the hydrogen generator may by shut down until such time as a hydrogen demand occurs or the amount of hydrogen in the reservoir is lowered to the second amount.

The apparatus may find attractive application in facilities that generate from about 1 to 1000, especially from about 2 to 100, kilograms of hydrogen per day.

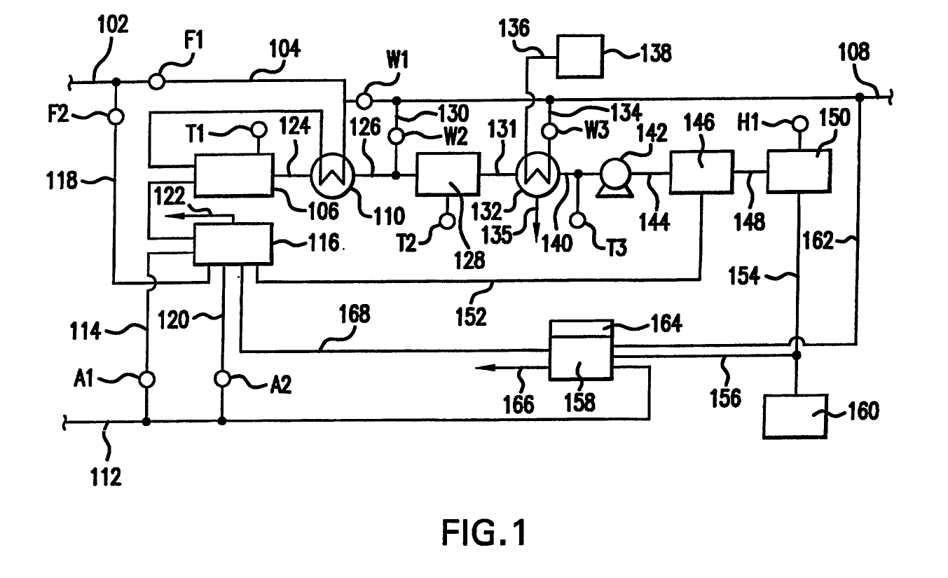

Preferred aspects of the invention will be further described in connection with the drawings. With reference to FIG. 1, hydrocarbon-containing fuel for the hydrogen generator is supplied via line 102. A portion of the fuel is passed via line 104 ultimately to reformer 106. The rate of flow of the fuel in line 104 is controlled by valve F1. Fuel passing through line 104 is admixed with water supplied by line 108 and controlled by valve W1. The water added to the fuel may be in the form of steam or may be liquid and converted to steam during preheating of the fuel for reforming. As shown, the fuel and water mixture is preheated in heat exchanger 110 which uses indirect heat exchange with the hot reformate from reformer 106.

The reformer depicted in the drawing is an autothermal reformer. Thus a supply of oxygen-containing gas is required. As shown, air is supplied by line 112 to the apparatus, and a portion of the air as controlled by valve A1 is passed via line 114 and through heat exchanger/combustor 116 to reformer 106 where it is combined with the fuel and water for the autothermal reforming. Reformer 106 is provided with thermocouple T1 to determine the temperature at which the reformer is operating.

As shown in the drawing, heat from combustion is also provided to the reformer. As depicted, this heat is used to preheat air. It could also be used to preheat other reactants or may be used for indirect heat exchange with the zone in which the reforming is occurring. Heat exchanger/combustor 116 is capable of combusting purge from the pressure swing adsorber, cathode waste gas from the fuel cell, and fuel with air. A portion of the fuel in line 102 is passed via line 118 having flow control valve F2 to combustor 116, and a portion of the air in line 112 is passed via line 120 having valve A2 to heat exchanger/combustor 116. The exhaust from heat exchanger/combustor 116 exits via line 122. The exhaust may be used for further heat recovery if desired.

The hot effluent gas from reformer 106, the reformate, is passed via line 124 to heat exchanger 110. The cooler reformate from the heat exchanger is typically still too warm for a water gas shift. Thus, the reformate which passes from heat exchanger 110 to water gas shift reactor 128 via line 126 is admixed with liquid water passing from line 108 via line 130 having control valve W2. The water is vaporized and with direct sensible heat exchange, the mixture of reformate and water is brought to the desired temperature for feed to water gas shift reactor 128. Theromocouple T2 is provided to monitor the temperature of the water gas shift.

The shift effluent from water gas shift reactor 128 is passed via line 131 to cooler/condenser 132. Water from line 108 is drawn off via line 134 having valve W3 for the cooling. Condensate is withdrawn from cooler/condenser 132 via line 135. The condensate may be discharged from the apparatus or used for heat recovery. The hot water from the indirect heat exchange in cooler/condenser is then passed via line 136 for use. The water may be used as a source of hot water, e.g., for residential or similar uses, or may be used a source of heat within the apparatus such as for preheating fuel or air or providing heat to a metal hydride reservoir for the release of hydrogen. Box 138 generally indicates a use for the hot water. The cooled shift effluent passes via line 140 to compressor 142. As shown, thermocouple T3 detects the temperature of the cooled shift effluent.

The compressed shift effluent is passed via line 144 to pressure swing absorber 146. The desorption cycle gas from the pressure swing absorber is passed via line 152 to combustor 116. The purified hydrogen product stream is then passed via line 148 to reservoir 150. Reservoir 150 is equipped with sensor H1 which determines the amount of hydrogen contained in the reservoir.

Hydrogen is withdrawn from reservoir 150 via line 154, and hydrogen, as needed, can pass via line 156 to fuel cell 158, and hydrogen, as needed can pass to supply point 160. Fuel cell 158 also receives water from line 108 via line 162 and air from line 112. As shown, fuel cell controller 164 is provided to control the feed to and operation of the fuel cell. Electrical power is withdrawn from fuel cell 158 via cable 166. A portion of the generated electricity can be used to meet the electrical demands of the apparatus. Since the hydrogen fed to the fuel cell is highly pure, it can be recycled and essentially no anode purge gas is generated. A cathode waste gas containing nitrogen and unreacted oxygen is exhausted from fuel cell 158 via line 168 and is passed to heat exchanger/combustor 116 as an additional source of oxygen and as a temperature moderator. Alternatively, the cathode waste gas may be exhausted.

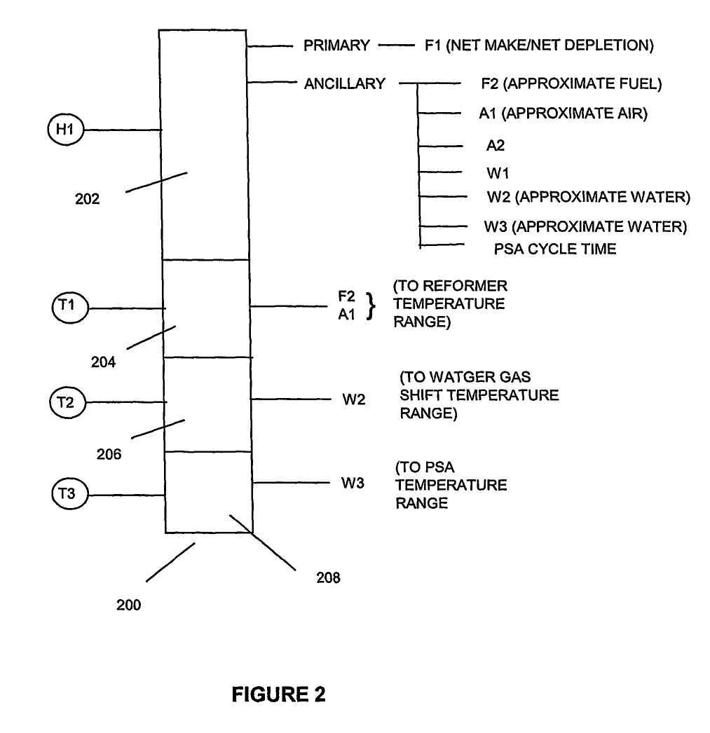

FIG. 2 schematically diagrams the control of the apparatus of FIG. 1. Numeral 200 generally indicates a computer-based control processor. Sensor H1 is in communication with the fuel supply routine 202 of the processor. The supply routine provides primary control to valve F1 which establishes the flow rate of fuel to be reacted in reformer 106. Based upon the signal from sensor H1, the subroutine will direct valve F1 to be position to provide fuel flow for a net hydrogen make or a net hydrogen depletion. The subroutine will also set various other valves and operations in the hydrogen generator. If the reforming involves a partial oxidation, the subroutine will set valve A1 for the flow of air to the reformer based upon the expected amount of air to be needed. As the composition of the fuel changes or the reforming catalyst deactivates, the predetermined amount of air predetermined by supply routine 202 may be inappropriate to maintain reformer within the desired temperature range. Hence, thermocouple Ti provides to subroutine 204 the reforming temperature that can then fine tune valve A1 to maintain a temperature within the sought range.

Subroutine 202 also sets valve F2 to provide the expected amount of fuel to heat exchanger/combustor 116 for providing heat for reforming. Again, changing fuel compositions, reforming catalyst deactivation, changes in the volume of cathode waste gas, fouling of the heat transfer surfaces and the like can occur and the actual quantity heat being transferred to the incoming air for reforming may be different than that predetermined by routine 202. The temperature of the reforming will reflect the actual heat being transferred and thus subroutine 204 can fine tune the flow through valve F2 based upon the signal from thermocouple T1 to bring the reforming temperature within the desired range.

Subroutine 202 also sets valve A2 for the air passing to heat exchanger/combustor 116. Typically, the predetermined amount of air for combustion can be in a significant excess of that required stoichiometrically and hence no fine tuning of this flow is usually done. Similarly, water is provided to reformer 106 in a substantial excess and the setting established by routine 202 generally requires no fine tuning.

Subroutine 202 also sets valve W2 for the supply of water for cooling the reformate and providing water for the shift reaction. As shift reactions are dependent upon temperature, thermocouple T2 is in communication with subroutine 206 for fine tuning this flow of water. Subroutine 202 sets valve W3 to control the flow of water to cooler/condenser 132. The temperature of the cooling water may change and the heat exchange surfaces may become fouled. Accordingly, subroutine 208 is provided, which in communication with thermocouple T3, fine tunes the flow of cooling water by further adjusting valve W3 such that the temperature of the shift effluent is within the desired range.

Subroutine 202 is used to control the cycle times for pressure swing adsorber 146. For simplifying control of the pressure swing adsorber, the cycle times, predetermined for each net hydrogen make rate and each net hydrogen depletion rate, will be conservative. Thus, the same cycle times will be acceptable as the reforming catalyst and water gas shift catalyst approach the end of their useful lives. Alternatively sensors could be used to determine the composition of the purified hydrogen product and an additional subroutine provided to fine tune the pressure swing adsorber cycle times.

As stated above, subroutines 204, 206 and 208 are used to fine tune the position of valves to maintain a temperature condition within a predetermined range. As the process uses a pressure swing absorber to purify the hydrogen, significant variations in reformate compositions and water gas shift effluent compositions can be tolerated while still providing hydrogen at acceptable purity levels. Hence the ranges can be relatively broad, e.g., as great as 10° C. or more. Thus the fine tuning can occur relatively easily and without a cyclic overshooting and undershooting of the target range. A failure of any of T1, T2 and T3 or the subroutines with which they communicate will not necessarily be fatal to the continued operation of the apparatus as subroutine 202 provides the coarse settings.

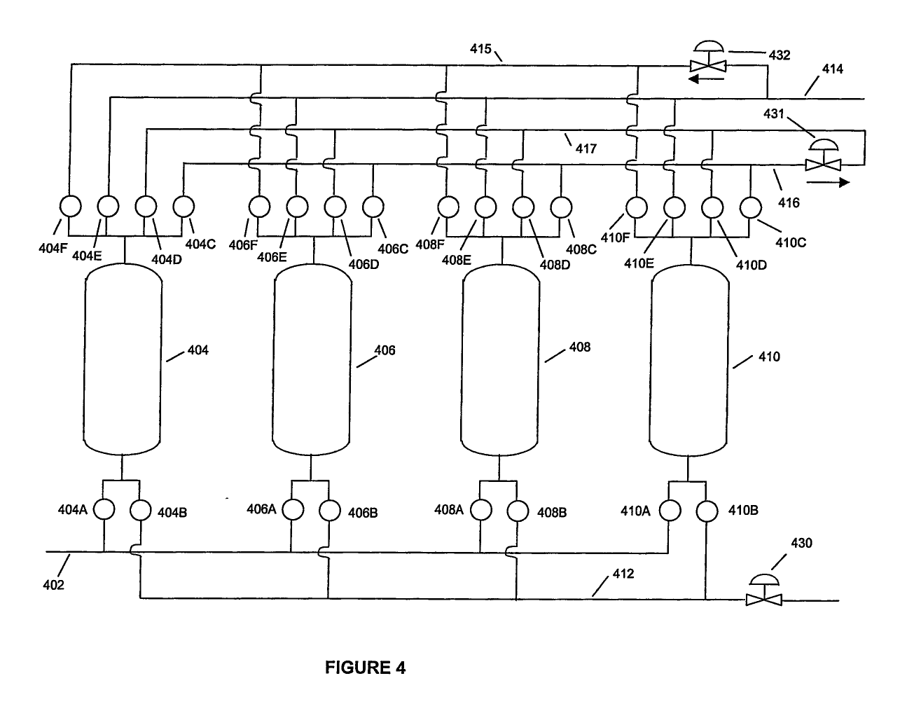

FIG. 4 depicts a four bed pressure swing adsorber useful for purifying hydrogen produced by autothermal reforming with air. A feed containing hydrogen, nitrogen, argon, water, carbon dioxide, carbon monoxide and any unreacted hydrocarbon-containing feedstock is passed via line 402 to one of vessels 404, 406, 408 and 410 which is in the adsorption phase of the cycle. Each of the vessels has a valve, 404A, 406A, 408A and 410A, respectively, to permit flow of the feed to the vessel at one end. Each of the vessels at the same end is in fluid communication with a purge header 412 through valves 404B, 406B, 408B and 410B. Each of the vessels is in fluid communication at the opposing end with purified product header 414 through valves 404E, 406E, 408E and 410E. Also on said opposing end, each vessel is in fluid communication with pressurization header 415 through valves 404F, 406F, 408F, and 410F. Further on said opposing end, each vessel is in fluid communication with provide equalization/provide purge header 416 through valves 404C, 406C, 408C, and 410C. Finally on said opposing end, each vessel is in fluid communication with receive equalization/receive purge header 417 through valves 404D, 406D, 408D, and 410D.

A proportional control valve 431 is provided on the equalization/purge header in order to control the rate of pressure change in the beds during provide purge and provide equalization steps. An additional proportional control valve 432 is provided on the pressurization header in order to control the rate of pressurization. A further control valve 430 is provided on the tail gas line 412 in order to control the rate of blowdown.

Each of the vessels is filled with adsorbent, e.g., a granular activated carbon adsorbent for about 30 volume percent of the bed closest to the feed inlet and the remainder being a beaded lithium exchanged X molecular sieve.

For the bed undergoing adsorption, its valves A and E are open and purified hydrogen product stream enters header 414. Once a bed goes off the adsorption step of the cycle valves A and E are closed and the C valve is opened. The gases, which primarily are those in the interstitial spaces in the vessel, are passed into header 416 and are introduced into the vessel undergoing repressurization through the D valve. Once the two vessels are at substantially the same pressure, the gases are passed to the vessel being purged. The purging is done at low pressure, e.g., less than about 50 kPa above ambient atmospheric pressure. After the purge step is completed, the B valve is closed at the bottom of the bed undergoing purge and the two beds equalize in pressure (second equalization). Following the second equalization, the C valve is closed and the B valve is opened and the pressure within the vessel is dropped to the low pressure for purging. Once this blow down is completed, the D valve is opened such that the gas from the vessel in the provide purge step of the cycle can purge the bed. In the next step, the B valve is closed and the bed is partially repressurized by equalizing pressure with another bed through the D valve. In the final step, the bed is further repressurized through the D valve by equalizing with another bed undergoing the first equalization step. Valve D is then closed after the pressure equalization is completed, and the purified hydrogen product stream continues to fill the vessel through the F valve until substantially the pressure for adsorption is reached. Valves A and E are then opened to restart the adsorption step.

Advantageously, the pressure swing adsorption unit in FIG. 4 is designed to use only two proportional control valves thereby simplifying automation, reducing the tuning requirements in the field, and improving operability.

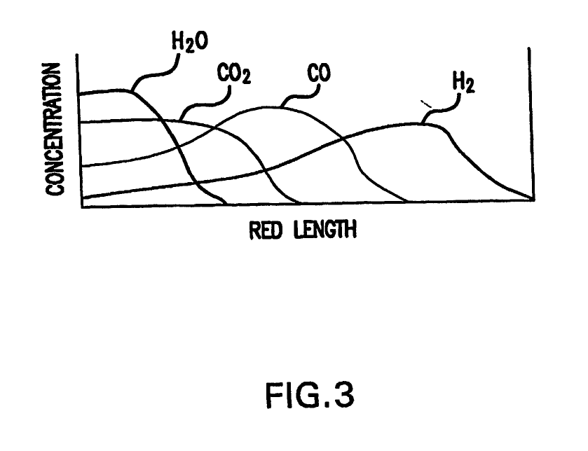

FIG. 3 is a simplified chart showing the adsorption of each component in the hydrogen feed over the length of the bed. In the section of the bed containing carbon, the water and carbon dioxide are effectively adsorbed. As the lithium X molecular sieve is more selective for the adsorption of carbon monoxide than nitrogen, carbon monoxide is effectively reduced well prior to the point of breakthrough from the bed, whereas the nitrogen front approaches breakthrough. Advantageously, the pressure equalization, which is a cocurrent flow operation, will be completed prior to any significant breakthrough of nitrogen. As can be seen, the carbon monoxide adsorption front will still be far from breakthrough. When the provide purge step is undertaken, the nitrogen will break through which will beneficially be useful as a sweep gas to reduce the partial pressure, and thus the desorption, of carbon monoxide in the bed undergoing the purge.

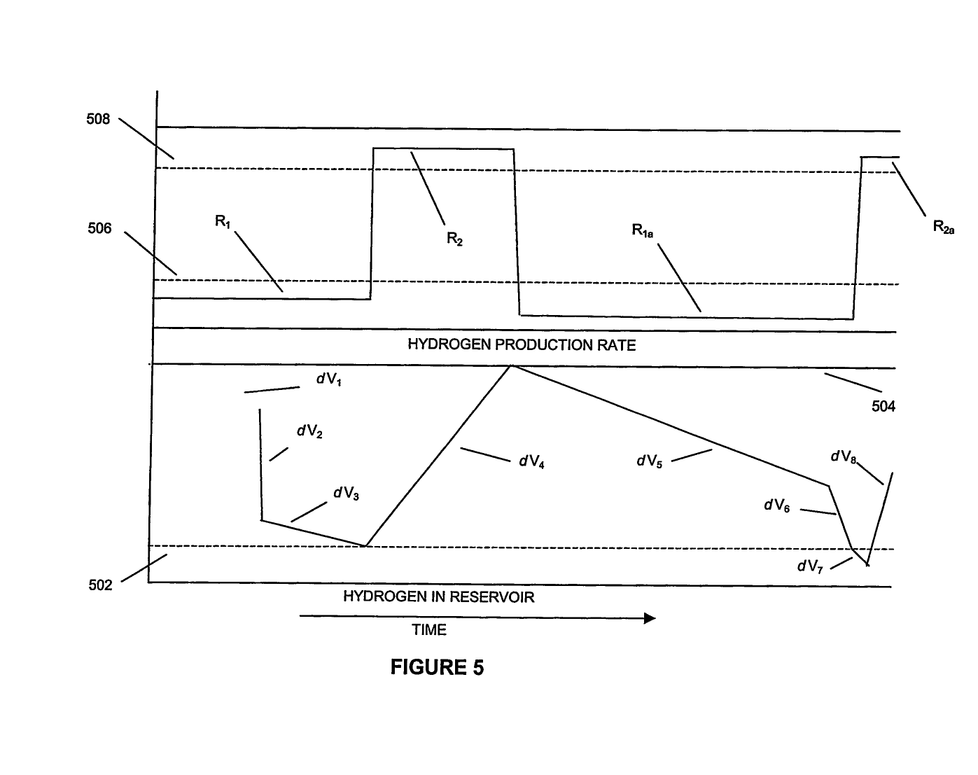

FIG. 5 is a graphic depiction of the hydrogen production rate and of the hydrogen in the reservoir over a duration of time in the operation of a process of this invention. With reference to the lower graph, line 502 is the predetermined amount of hydrogen at which the rate of hydrogen production is changed from a net hydrogen loss rate to a net hydrogen make rate. Line 504 depicts the top fill amount for the reservoir, i.e., the point at which the rate of hydrogen production changes from a net make rate to a net loss rate. The upper graph depicts the rate of hydrogen make. Line 506 is the upper boundary of the net hydrogen loss rate. Thus hydrogen production anywhere below the rate specified by line 506 would be a net hydrogen loss rate. Line 508 is the lower boundary of the net hydrogen make rate, and a rate of hydrogen production above the rate specified by line 508 would be a net hydrogen make rate.

As shown for purposes of illustration, hydrogen is initially being produced at R₁, which rate is insufficient to keep up with the hydrogen demand (e.g., the hydrogen is being used in a fuel cell to generate electricity), and thus the volume of hydrogen in the reservoir decreases at a rate dV₁. At a point in time, an episodic withdrawal of hydrogen occurs such as for filling a hydrogen fuel tank for a vehicle. The rate of withdrawal becomes very rapid as indicated by dV₂. Upon completion of the withdrawal, the rate of hydrogen withdrawal resumes at a slower pace dV₃ until the volume of hydrogen in the reservoir drops to the predetermined amount represented by line 502 where the hydrogen generation rate then becomes a net hydrogen make rate. As shown in the upper portion of the drawing, hydrogen is produced at rate R₂. Hydrogen accumulates in the reservoir at rate dV₄ even though hydrogen is continuing to be withdrawn as a feed to the fuel cell. Once the reservoir is filled, the hydrogen production rate is dropped to a net hydrogen loss rate R₁ₐ.

Hydrogen production rate R₁ₐ is shown as being less than R₁ and is shown to decrease over time. While not necessarily representative of an actual operation, it does illustrate several features of the invention. First, it shows that it is not necessary to resume hydrogen production at rate R₁. The decrease in rate may be due to a change in feedstock or change or other cause such as catalyst aging or equipment problems. Because the rate of hydrogen production is decreased, the rate of hydrogen depletion (dV₅) in the reservoir will be increased to meet the demand of the fuel cell.

At some point in time, another episodic hydrogen withdrawal occurs. The rate of withdrawal goes up as shown by dV₆. Prior to the end of the episodic withdrawal, the amount of hydrogen in the reservoir falls below the trigger value of line 502 and the production rate of hydrogen is increased to R₂ₐ. R₂ₐ is a net hydrogen production rate. As shown, it is a different rate than R₂ for any of the reasons discussed above with respect to rate R₁. However, as an episodic withdrawal is occurring, it is not essential in accordance with the broad aspects of the invention that R₂ₐ be a net hydrogen make for an episodic withdrawal. Accordingly, the episodic withdrawal continues (dV₇) with further reduction in the volume of hydrogen in the reservoir. Upon completion of the episodic withdrawal, hydrogen is replenished (dV₈) at the net hydrogen make rate R₂ₐ.

The advantages provided by the control methods of this invention are readily apparent from the above discussion.

All parts and percentages herein are on a mole basis and on a dry basis unless otherwise stated or clear from the context. All pressures are gauge unless otherwise stated or clear from the context.

What is claimed is:

1. A method for controlling a process for generating hydrogen by reforming a hydrocarbon-containing feed at elevated temperature in the presence of water to produce a reformate containing at least about 3 volume percent carbon monoxide (dry basis), reducing the carbon monoxide content of the reformate to provide a purified hydrogen product having less than about 100 parts per million by volume of carbon monoxide (dry basis), maintaining a reservoir of hydrogen from reforming, and withdrawing hydrogen from the reservoir comprising:
a) generating hydrogen at a rate within a first rate range sufficient to accumulate hydrogen in the reservoir,
b) upon a predetermined first amount of hydrogen being accumulated in the reservoir, changing the rate of hydrogen generation to a rate within a second rate range insufficient to maintain the first amount of hydrogen in the reservoir, and
c) upon a predetermined second amount of hydrogen being in the reservoir, said second amount being less than the first amount, changing the rate of hydrogen generation to a rate within said first rate range.

2. The method of claim 1 wherein the hydrogen maintained in the reservoir is purified hydrogen product and is withdrawn from the reservoir at different rates during over time.

3. The method of claim 2 wherein hydrogen is withdrawn from the reservoir at varying rates for generating electricity in a fuel cell.

4. The method of claim 3 wherein hydrogen is withdrawn from the reservoir on an episodic basis for other purposes, and the capacity of the reservoir is sufficient to supply hydrogen to meet peak demands.

5. The method of claim 2 wherein a transition period exists during the changing of the rate of hydrogen generation from the first rate to the second rate, and the capacity of the reservoir is less than 2 times that equivalent to the incremental amount of purified hydrogen product that would have been produced during the transition period at the second rate less that which would have been produced during the transition period at the first rate.

6. The method of claim 4 wherein the capacity is less than that equivalent to said incremental amount.

7. A method for controlling a combined process for generating hydrogen and using hydrogen for generating electrical power by reforming a hydrocarbon-containing feed at elevated temperature in the presence of water to produce a reformate containing at least about 3 volume percent carbon monoxide (dry basis), providing the reformate at a pressure and temperature suitable for pressure swing adsorption to obtain a purified hydrogen stream, recovering hydrogen from the reformate by pressure swing adsorption to provide a purified hydrogen product stream containing at least 98 volume percent hydrogen and less than about 100 parts per million by volume of carbon monoxide (dry basis) at least a portion of which purified hydrogen product stream is used to generate electrical power by reaction with oxygen in a fuel cell and to provide a purge stream containing hydrogen and carbon monoxide at least a portion of which purge stream is combusted to provide heat for the reforming, and maintaining a reservoir of the purified hydrogen product stream comprising:
a) generating hydrogen at a first rate within a first rate range sufficient to accumulate purified hydrogen stream in the reservoir,
b) upon a predetermined first amount of purified hydrogen stream being accumulated in the reservoir, changing the rate of hydrogen generation to a second rate within a second rate range insufficient to maintain the first amount of purified hydrogen stream in the reservoir, and
c) upon a predetermined second amount of purified hydrogen stream being in the reservoir, said second amount being less than the first amount, changing the rate of hydrogen generation to a rate said first rate range.

8. The method of claim 7 wherein the reformate is subjected to carbon monoxide-reducing conditions prior to the pressure swing adsorption.

9. The method of claim 8 wherein hydrogen is withdrawn from the reservoir on an episodic basis for other purposes, and the capacity of the reservoir is sufficient to supply hydrogen to meet peak demands.

10. The method of claim 7 wherein the second rate of hydrogen generation is nil.

11. The method of claim 7 wherein the second rate of hydrogen generation is at least about 20 percent of the first rate of hydrogen generation.

12. The method of claim 11 wherein the reforming is maintained within a predetermined temperature range at the first rate of hydrogen generation and at the second rate of hydrogen generation by adjusting the amount of combustion providing heat for reforming.

13. The method of claim 12 wherein the combustion comprises the combustion of the purge stream and combustion of hydrocarbon-containing feed.

14. The method of claim 13 wherein the reforming is steam reforming and the combustion provides heat through indirect heat exchange.

15. The method of claim 13 wherein the reforming comprises a partial oxidation of hydrocarbon-containing feed fed to the reforming and oxygen-containing gas is also fed to the reforming.

16. The method of claim 15 wherein the reforming is an autothermal reforming.

17. The method of claim 15 wherein the volume ratio of hydrocarbon-containing feed to oxygen-containing gas is adjusted to maintain the reforming within the predetermine temperature range.

18. The method of claim 17 wherein the rate of hydrocarbon-containing feed to the reforming is the primary variable changed when changing the rate of hydrogen generation and the rate of oxygen-containing gas is adjusted to maintain the reformer within the predetermined temperature range, and the rate of production of purified hydrogen product stream is that produced at the given hydrocarbon-containing feed rate.

19. The method of claim 7 wherein the combustion of the purge is used to preheat the hydrocarbon-containing feed for the reforming.

20. The method of claim 7 wherein the reforming comprises a partial oxidation of hydrocarbon-containing feed fed to the reforming and oxygen-containing gas is also fed to the reforming, and the combustion of the purge is used to preheat the oxygen-containing gas for the reforming.

21. The method of claim 7 wherein the rate of hydrocarbon-containing feed to the reforming is the primary variable changed when changing the rate of hydrogen generation and the rate of hydrocarbon-containing fuel for the combustion is adjusted to maintain the reformer within the predetermined temperature range, and the rate of production of purified hydrogen stream is that produced at the given hydrocarbon-containing feed rate.

22. The method of claim 7 wherein the reformate is provided at a pressure suitable for pressure swing adsorption by compressing the hydrocarbon-containing feed for reforming.

23. The method of claim 7 wherein the reformate is provided at a pressure suitable for pressure swing adsorption by compressing the hydrocarbon-containing feed and the oxygen-containing gas for reforming.

24. A process for generating hydrogen comprising reforming a hydrocarbon-containing feed at elevated temperature in the presence of water and nitrogen and oxygen-containing gas whereby a portion of the feed is partially combusted to provide heat for reforming to produce a reformate containing water, hydrogen, nitrogen, carbon dioxide and at least about 3 volume percent (dry basis) carbon monoxide, providing the reformate at a pressure and temperature suitable for pressure swing adsorption to obtain a purified hydrogen stream, recovering from the reformate during an adsorption cycle of a pressure swing adsorber hydrogen a purified hydrogen product stream containing at least 98 volume percent hydrogen and less than about 100 parts per million by volume of carbon monoxide (dry basis) and provide during a purge cycle a purge stream containing nitrogen, carbon dioxide, hydrogen and carbon monoxide at least a portion of which purge stream is combusted to provide heat for the reforming, in which the rate of hydrogen production is changed from a first rate to a second rate and a substantially constant pressure swing cycle time is maintained for the adsorption at each such rate and the purity of the purified hydrogen stream varies.

25. The process of claim 24 wherein the reformate is subjected to carbon monoxide-reducing conditions prior to the pressure swing adsorption.

26. The process of claim 25 wherein the carbon monoxide-reducing conditions comprise subjecting the reformate to water gas shift conditions including the presence of a water gas shift catalyst and in the presence of water to react carbon monoxide with water to produce a shift effluent containing at least about 0.1 volume percent carbon monoxide (dry basis), cooling the shift effluent to a temperature below about 100° C. and removing therefrom condensed water.

27. The process of claim 24 wherein a reservoir of hydrogen generated by the reforming is maintained.

28. The process of claim 24 wherein a purge gas is used during the purge cycle of the pressure swing adsorber, said adsorber having at least four cycling beds such that at least one of which is undertaking adsorption, another of which is being purged, another of which is being repressurized and another of which is providing purge gas to the bed being purged.

29. The process of claim 28 wherein the bed being repressurized comprises a reservoir for hydrogen from the reforming.
